(19) United States
(12) Patent Application Publication
(10) Pub. No.: US 2024/0325895 A1
(43) Pub. Date: Oct. 3, 2024

(54) NON-TRANSITORY COMPUTER-READABLE MEDIUM AND VIDEO GAME PROCESSING SYSTEM

(71) Applicant: SQUARE ENIX CO., LTD., Tokyo (JP)

(72) Inventors: Kazutoyo MAEHIRO, Tokyo (JP); Momoka AONO, Tokyo (JP)

(73) Assignee: SQUARE ENIX CO., LTD., Tokyo (JP)

(21) Appl. No.: 18/625,932

(22) Filed: Apr. 3, 2024

(30) Foreign Application Priority Data
Apr. 3, 2023 (JP) 2023-060445
May 25, 2023 (JP) 2023-086282

(51) Int. Cl. A63F 13/53; A63F 13/35; A63F 13/69; G06F 16/435

(52) U.S. Cl. CPC A63F 13/53; A63F 13/35; A63F 13/69; G06F 16/435

(57) ABSTRACT

One or more embodiments of the disclosure provide a non-transitory computer-readable medium storing a video game processing program that, when executed, causes a server to perform: specifying one or more terms that satisfy a search target condition in accordance with a progress of a video game from among a plurality of terms that appear in the video game; deciding search information based on an operation of a player; selecting a predetermined number of terms from among the specified one or more terms based on the search information; and displaying the selected predetermined number of terms.

### CROSS-REFERENCE TO RELATED APPLICATION

The present application claims priority to and the benefit of Japanese Patent Application No. 2023-060445 filed on Apr. 3, 2023, and No. 2023-086282 filed on May 25, 2023, the disclosures of which are expressly incorporated herein by reference in their entirety for any purpose.

### BACKGROUND

Conventionally, various systems for information retrieval have been proposed.

In such a system, for example, based on state information corresponding to a current information search request, corresponding information is searched from a database in which information corresponding to the information search request is registered Japanese Patent Application Publication No. 2007-58830

### SUMMARY

However, most of the conventional systems search for information from a defined information group, and it cannot be said that the conventional systems are sufficiently studied from the viewpoint of meeting the demand of a user (i.e., a player) who plays a video game. Therefore, for example, even if a terminology group in which terms and descriptions appearing in a video game are grouped is prepared, in a case where it is difficult for a player to find information, the player does not try to know the information in the game and interrupts game play in an attempt to obtain knowledge from an information source outside the game such as an attack site, and as a result, interest in the game may be reduced.

It is an object of at least one embodiment of the present invention to provide a video game processing program and a video game processing system capable of providing information without impairing the sense of immersion in a video game of a player.

### Means for Solving the Problem

According to a non-limiting aspect, a video game processing program according to one embodiment of the present invention is a non-transitory computer-readable medium storing a video game processing program that, when executed, causes a server to perform: specifying one or more terms that satisfy a search target condition in accordance with a progress of a video game from among a plurality of terms that appear in the video game; deciding search information based on an operation of a player; selecting a predetermined number of terms from among the specified one or more terms based on the search information; and displaying the selected predetermined number of terms.

According to a non-limiting aspect, a video game processing system according to one embodiment of the present invention is a video game processing system comprising: a communication network; a server; a player terminal; and one or more processors configured to: specify one or more terms that satisfy a search target condition in accordance with a progress of a video game from among a plurality of terms that appear in the video game; decide search information based on an operation of a player; select a predetermined number of terms from among the specified one or more terms based on the search information; and display the selected predetermined number of terms.

According to a non-limiting aspect, a video game processing program according to one embodiment of the present invention is a non-transitory computer-readable medium storing a video game processing program that, when executed, causes a player terminal to perform: specifying one or more terms that satisfy a search target condition in accordance with a progress of a video game from among a plurality of terms that appear in the video game; deciding search information based on an operation of a player; selecting a predetermined number of terms from among the specified one or more terms based on the search information; and displaying the selected predetermined number of terms.

According to each embodiment of the disclosure, one or more problems are solved.

### BRIEF DESCRIPTION OF DRAWINGS

FIG. 1 is a block diagram showing an example of a configuration of a video game processing system corresponding to at least one embodiment of the present invention.

FIG. 2 is a block diagram showing a configuration of a server corresponding to at least one of the embodiments of the present invention.

FIG. 3 is a flowchart showing an example of a game process corresponding to at least one of the embodiments of the present invention.

FIG. 4 is a flowchart showing an example of the operation on the server side in the game process corresponding to at least one of the embodiments of the present invention.

FIG. 5 is a flowchart showing an example of the operation on the terminal side in the game process corresponding to at least one of the embodiments of the present invention.

FIG. 6 is a block diagram showing a configuration of a server corresponding to at least one of the embodiments of the present invention.

FIG. 7 is a flowchart showing an example of a game process corresponding to at least one of the embodiments of the present invention.

FIG. 8 is a block diagram showing a configuration of a server corresponding to at least one of the embodiments of the present invention.

FIG. 9 is a flowchart showing an example of a game process corresponding to at least one of the embodiments of the present invention.

FIG. 10 is an explanatory diagram for explaining an example of a storage state of information corresponding to at least one of the embodiments of the present invention.

FIG. 11 is an explanatory diagram showing an example of a game screen corresponding to at least one of the embodiments of the present invention.

### DETAILED DESCRIPTION

Hereinafter, an example of an embodiment of the present invention will be described with reference to the drawings. Various constituent elements in the examples of the embodiments described below can be appropriately combined within a range in which no contradiction or the like occurs. Further, description of the content described as an example of a certain embodiment may be omitted in other embodiments. Further, the contents of operations and processes not related to the characteristic portions of the embodiments may be omitted. Further, the order of various processes constituting various flows described below is not the same as long as no contradiction occurs in the contents of the processes.

### First Embodiment

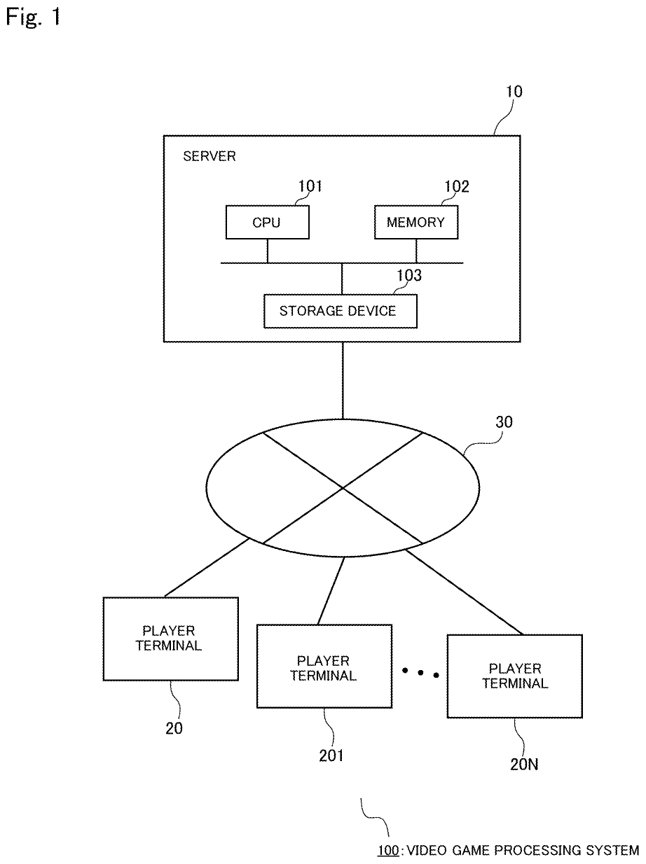

FIG. 1 is a block diagram showing an example of a configuration of a video game processing system 100 according to an embodiment of the present invention. As shown in FIG. 1, the video game processing system 100 includes a video game processing server 10 (server 10) and player terminals (player terminals) 20, 201 to 20N (N is an arbitrary integer) used by a player of the video game processing system 100. Note that the configuration of the video game processing system 100 is not limited to this, and a configuration may be adopted in which a single player terminal is used by a plurality of players, or a configuration may be adopted in which a plurality of servers are provided.

The server 10 and the plurality of player terminals 20 and 201 to 20N are connected to a communication network 30 such as the Internet. Although not shown, the plurality of player terminals 20 and 201 to 20N are connected to the communication network 30 by performing data communication with a base station managed by a communication provider via a wireless communication line.

The video game processing system 100 includes a server 10 and a plurality of player terminals 20 and 201 to 20N, thereby realizing various functions for executing various processes in accordance with an operation of a player.

The server 10 is managed by an administrator of the video game processing system 100, and has various functions for providing information related to various processes to the plurality of player terminals 20 and 201 to 20N. In the present example, the server 10 is configured by an information processing apparatus such as a WWW server, and includes a storage medium that stores various kinds of information. The configuration of the server 10 is not particularly limited as long as it includes a general configuration for performing various processes as a computer, such as a control unit and a communication unit. Hereinafter, an example of a hardware configuration of the server 10 will be briefly described.

As illustrated in FIG. 1, the server 10 includes at least CPU (Central Processing Unit) 101, a memory 102, and a storage device 103.

The CPU 101 is a central processing unit that performs various calculations and controls. When the server 10 includes a GPU (Graphics Processing Unit), a part of various calculations and controls may be performed by the GPU. The server 10 causes the CPU 101 to execute various kinds of information processing necessary for controlling the video game by using the data read out to the memory 102 as appropriate, and stores the obtained processing result in the storage device 103 as necessary.

The storage device 103 has a function as a storage medium for storing various kinds of information. The configuration of the storage device 103 is not particularly limited, but from the viewpoint of reducing the processing load on each of the plurality of player terminals 20 and 201 to 20N, it is preferable to have a configuration capable of storing all the various kinds of information necessary for controlling the video game. Such examples include HDDs and SSDs. However, the storage unit that stores various kinds of information may include a storage area in a state accessible by the server 10, and may have, for example, a dedicated storage area outside the server 10.

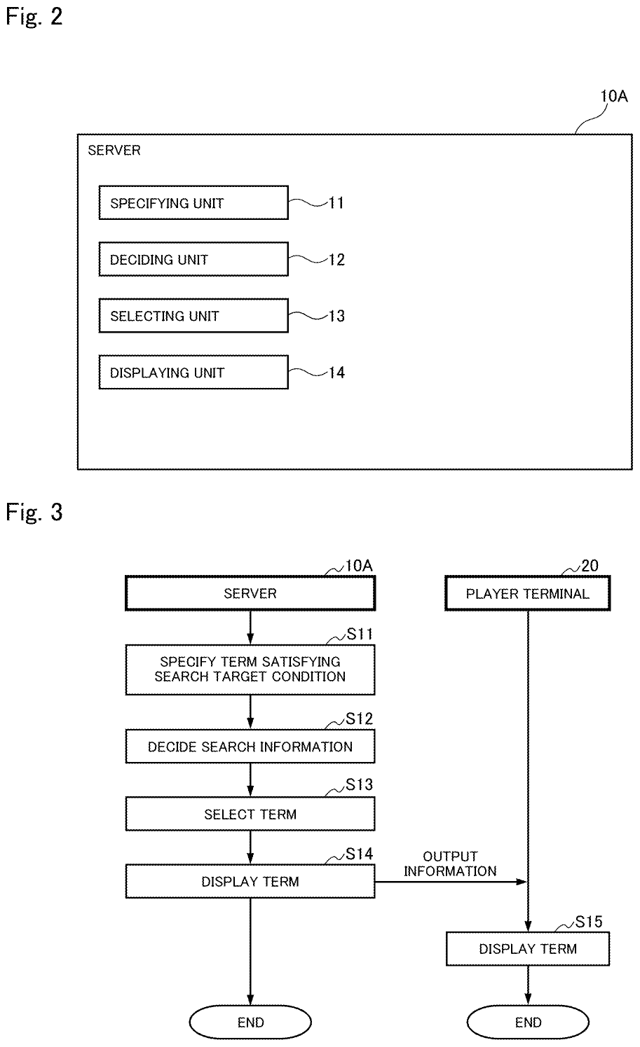

FIG. 2 is a block diagram showing a configuration of a video game processing server 10A (server 10A) which is an example of a configuration of the video game processing server 10. As illustrated in FIG. 2, the server 10A includes at least a specifying unit 11, a deciding unit 12, a selecting unit 13, and a displaying unit 14.

The specifying unit 11 has a function of specifying, one or more terms that satisfy a search target condition in accordance with a progress of a video game from among a plurality of terms that appear in the video game.

Here, the relationship between the term appearing in the video game and the condition to be searched is not particularly limited, but it is preferable that a condition in which it is estimated that the term is grasped while the player plays the video game is associated with the condition to be searched of the term. As an example of the term and the condition to be searched, there is a case where a serif including the term is spoken by the character.

In addition, the configuration for specifying the term satisfying the condition to be searched in accordance with the progress of the video game is not particularly limited, and the specification may be always performed in accordance with the progress of the game, or may be collectively performed in a specific scene. Note that the progress of the video game means various progresses that may occur in the video game. Examples of the progress of the video game include a scenario progress, a moving image reproduction, and a change in a player position or a character position. It should be noted that the progress of the video game in the present example also includes a case in which the player has selected moving image reproduction through a “UI (moving image reproduction menu)” or the like in which an event scene can be returned. That is, the information specified as the progress of the video game includes information specifying a moving image reproduced in accordance with the player's operation.

The deciding unit 12 has a function of deciding search information based on a player operation.

Here, the search information means information used to search for a term. The configuration of the search information is not particularly limited, but it is preferable that the player can recognize the relationship with the term. Examples of the search information include a character string indicating a term and a category to which the term belongs.

The configuration for deciding the search information based on the player operation is not particularly limited, and the character string input by the player may be decided as the search information, or the category may be decided as the search information when the player selects the category displayed on the game screen.

The selecting unit 13 has a function of selecting a predetermined number of terms from among the terms that satisfy the search target condition based on the search information.

Here, a configuration for selecting a predetermined number of terms is not particularly limited, and a configuration may be adopted in which a predetermined number (For example, five as the display upper limit number.) of a plurality of terms searched by term search using search target conditions are selected, or a configuration may be adopted in which one term is selected from the searched terms in accordance with a predetermined rule.

The displaying unit 14 has a function of displaying a predetermined number of terms selected by the selecting unit 13.

Here, the configuration for displaying the predetermined number of terms is not particularly limited as long as the player can recognize the terms. Examples of the configuration for displaying the term include a configuration for displaying a game screen including an image representing the term and a configuration for displaying a game screen including the term and a description of the term.

Each of the plurality of player terminals 20 and 201 to 20N is managed by a player, and is configured by a communication terminal capable of performing a network distribution type game, such as a mobile phone terminal, PDA (Personal Digital Assistants), a mobile game apparatus, or a so-called wearable device. Note that the configuration of the player terminal that can be included in the video game processing system 100 is not limited to the example described above, and may be any configuration as long as the player can recognize the contents of the video game. Other examples of the configuration of the player terminal include a combination of various communication terminals, a personal computer, and a stationary game apparatus.

Each of the plurality of player terminals 20 and 201 to 20N includes hardware (For example, a display device that displays a browser screen or a game screen according to coordinates.) and software for performing various processes by connecting to the communication network 30 and communicating with the server 10. Each of the plurality of player terminals 20 and 201 to 20N may be configured to directly communicate with each other without using the server 10.

Next, the operation of the video game processing system 100 (system 100) of the present example will be described.

FIG. 3 is a flowchart showing an example of game processing executed by the system 100. In the game process in the present example, a process related to controlling the progress of the video game in accordance with the operation of the player of the player terminal 20 (terminal 20) is performed. Hereinafter, a case where the server 10A and the terminal 20 execute game processing will be described as an example.

The game process is started, for example, when the system 100Z receives an operation input by the player.

In the game process, the server 10A first specifies a term satisfying the condition to be searched (step S11). In the present example, the server 10A specifies the term output in accordance with the progress of the video game among the terms for which the condition to be searched is set as the term satisfying the condition to be searched.

After specifying the term, the server 10A decides search information (step S12). In the present example, the server 10A decides the character string input by the player as the search information.

Upon deciding the search information, the server 10A selects a term (step S13). In the present example, the server 10A selects a predetermined number of terms according to the priority rule from the terms associated with the character string input by the player.

When the term is selected, the server 10A displays the term (step S14). In the present example, the server 10A generates output information for causing the player terminal 20 to output the selected predetermined number of terms, and transmits the generated output information to the player terminal 20.

The terminal 20 displays the term based on the output information received from the server 10A (step S15). After displaying the terminology, the terminal 20 transmits the operation information received from the player to the server 10A, thereby causing the server 10A to progress the video game.

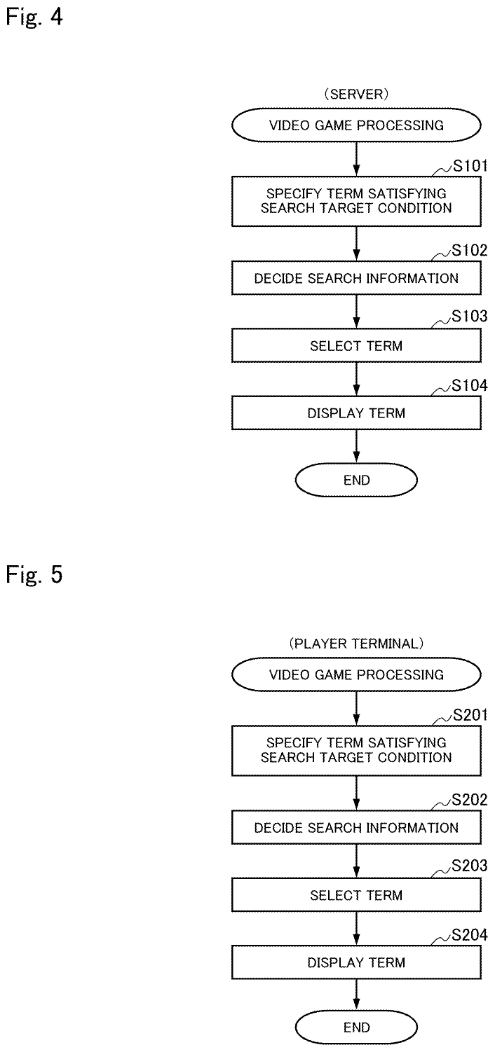

FIG. 4 is a flowchart illustrating an example of the operation of the server 10A side in the game process. Here, the operation of the server 10A in the system 100 will be described again.

In the game process, the server 10A first specifies a term satisfying the condition to be searched (step S101), decides search information (step S102), selects a term (step S103), and displays the term (step S104).

FIG. 5 is a flowchart illustrating an example of the operation of the terminal 20 when the terminal 20 executes the game process. Hereinafter, a case where the terminal 20 executes the game process by itself will be described as an example. Since the configuration of the terminal 20 has the same function as the configuration of the server 10 except that various kinds of information are received from the server 10, the description thereof is omitted from the viewpoint of avoiding redundant description.

In the game process, the terminal 20 first specifies a term satisfying the condition to be searched (step S201), determines search information (step S202), selects a term (step S203), and displays the term (step S204). In the present example, the terminal 20 acquires information used in each step by communicating with the server 10A. Note that the terminal 20 may be configured to specify information used in each step with reference to a storage unit included therein.

As described above, as one aspect of the first embodiment, since the server 10A that controls the progress of the video game is configured to include the specifying unit 11, the deciding unit 12, the selecting unit 13, and the displaying unit 14, among terms appearing in the video game, terms satisfying the conditions to be searched in accordance with the progress of the video game are identified, search information is determined based on a player's operation, and a predetermined number of terms are selected from terms satisfying the conditions to be searched based on the search information, the selected predetermined number of terms can be displayed so that information can be provided without impairing the player's sense of immersion in the video game.

That is, since the search target changes in accordance with the progress of the video game, it becomes easy for the player to check terms in the game, and it becomes easy for the player to enjoy even changed contents, and therefore, it becomes possible to prevent the sense of immersion of the player in the video game from being impaired as compared with the case where the player searches for terms from information outside the video game.

### Second Embodiment

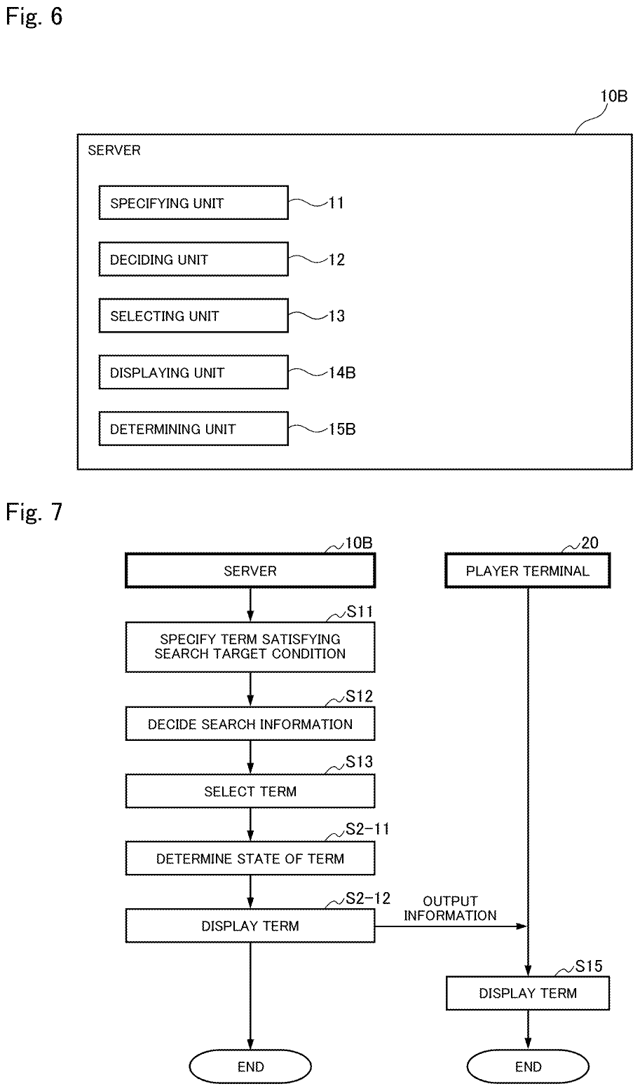

FIG. 6 is a block diagram showing a configuration of a video game processing server 10Z (server 10Z) which is an example of the video game processing server 10. In the present example, the server 10B includes at least a specifying unit 11, a deciding unit 12, a selecting unit 13, a displaying unit 14B, and a determining unit 15B.

The determining unit 15B has a function of determining which state among the predetermined number of states the term is in.

Here, the configuration for distinguishing the state of the term is not particularly limited, but it is preferable that the player can grasp the state. In an example of such a configuration, when a term or a target (For example, a term indicating a character name or an image of a character indicated by the term.) corresponding to the term is displayed on the game screen, it is determined that the player visually recognizes the term through the play of the video game, and the state of the term is classified into a “unknown state” and a “known state”. In addition, the type of the state to be classified is not particularly limited, but it is preferable to include a state in which the player merely visually recognizes the state and a state in which the player experiences the state. Examples of such states include three categories: a state (For example, terms that are not displayed during play.) in which the player does not know through play of the video game, a state (For example, terms displayed during play.) in which the player has heard but is not experienced, and a state (for example, a term indicating an item used by the player or an area reached) in which the player has been experienced.

The displaying unit 14B has a function of displaying the term in a manner corresponding to the state of the term.

Here, the mode corresponding to the state of the term is not particularly limited, but is preferably a mode in which the player can recognize that the state represents the term. Examples of such an aspect include an aspect in which only the existence of a term is represented as an aspect corresponding to a state that the player does not know through play of the video game, an aspect in which a character string corresponding to a state that the player has heard but is not experienced, and an aspect in which a character string and an image corresponding to a state that the player has experienced are represented. Although the configuration for determining whether or not the player has finished the experience corresponding to the term is not particularly limited, it is preferable that the player can recognize the determination result. In an example of such a configuration, the presence or absence of experience is determined based on the fact that the player visually recognizes the target corresponding to the term. In this case, for example, when the appearance of the person X appears in a cut scene, an event, or the like with respect to the term 1 meaning the specific person X, it is determined that the term 1 has been experienced by the player.

In addition, the configuration for displaying terms in each mode is not particularly limited, and a plurality of images representing a plurality of terms may be displayed in a list in a corresponding display mode, or may be displayed separately in each display mode.

FIG. 7 is a flowchart showing an example of a game process corresponding to at least one of the embodiments of the present invention. Hereinafter, operations of the server 10B and the terminal 20 will be described as an example. Note that the description of the flowcharts illustrating the operations of the server 10B and the terminal 20 will be omitted from the viewpoint of avoiding redundant description.

The game process is started, for example, when the server 10B determines that a situation in which it is determined whether or not the condition to be selected for the term is satisfied has occurred.

When selecting a term in the game process, the server 10B determines the state of the term (step S2-11). In this example, the server 10B determines which of the three divided states the term is in.

After determining the state of the term, the server 10B displays the term (step S2-12). In the present example, the server 10B transmits the output information to the terminal 20 so that the game screen including the image corresponding to the term is displayed on the terminal 20 in a manner corresponding to the state of the term.

As described above, as one aspect of the second embodiment, as one aspect of the first embodiment, since the server 10A that controls the progress of the video game is configured to include the specifying unit 11, the deciding unit 12, the selecting unit 13, the displaying unit 14B, and the determining unit 15B, it is determined which state the term is in among the states divided into a predetermined number, the term is displayed in a mode corresponding to the state of the term, and the information includes “information that is not known” and “information that is not experienced when hearing is performed”, it is possible to provide three-stage classification of “experienced information”, and it is possible to prevent the player's sense of immersion in the video game from being impaired.

### Third Embodiment

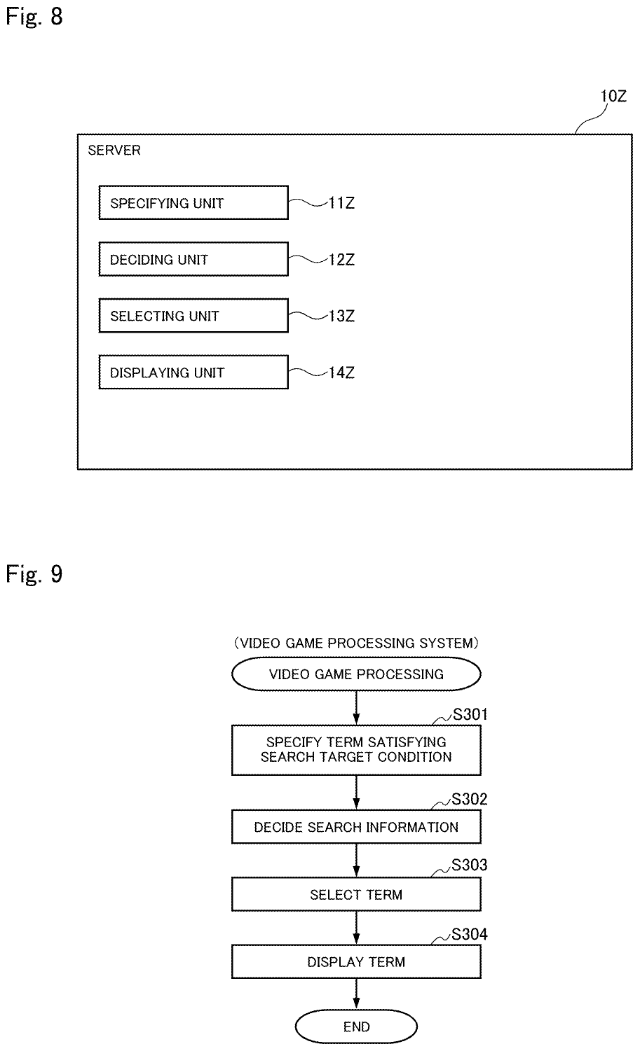

FIG. 8 is a block diagram showing a configuration of a video game processing server 10Z (server 10Z) which is an example of the video game processing server 10. In the present example, the server 10Z includes at least a specifying unit 11Z, a deciding unit 12Z, a selecting unit 13Z, and a displaying unit 14Z.

The specifying unit 11Z has a function of specifying, among a plurality of terms appearing in the video game, one or more terms satisfying the condition to be searched in accordance with the progress of the video game.

Here, the progress of the video game means various progresses that may occur in the video game. In the present example, the specifying unit 11Z specifies a term that appears when the player progresses the video game as a term satisfying the selected condition.

The deciding unit 12Z has a function of deciding search information based on a player operation.

Here, the search information means information used to search for a term. In this example, the deciding unit 12Z decides the character string input by the player and the category selected by the player as the search information. Note that the configuration for receiving the input of the character string by the player is not particularly limited, and a configuration may be adopted in which the input of the character string (including one character) according to the keyboard operation is received, or a configuration may be adopted in which the input is received through an operation on the game screen in which the initial character of the term is selectably displayed.

The selecting unit 13Z has a function of selecting a predetermined number of terms from the terms satisfying the conditions to be searched based on the search information.

Here, a configuration for selecting a predetermined number of terms is not particularly limited, but a configuration in which terms considered useful to the player are preferentially selected is preferable. As an example of such a configuration, there is a configuration capable of realizing a tag search for searching for a term including a character string input as a search key. Note that the configuration for selecting the term is not limited to the tag search, and various configurations such as selection based on the game progress of the player and selection based on the term name are assumed. In this example, when the player inputs a character string, the selecting unit 13Z selects a predetermined number of terms including the character string in the explanatory sentence. That is, in this example, a predetermined number of terms are selected as a result of searching for a character string input by the player. Here, the tag search refers to a search in which tag data for search is set in a term and the tag data is referred to during the term search. By using the tag search as the search method of the term, it is possible to avoid a difference depending on the language or an unintended item being selected and displayed.

The displaying unit 14Z has a function of displaying a predetermined number of terms selected by the selecting unit 13Z.

Here, the configuration for displaying the predetermined number of terms is not particularly limited as long as the player can recognize the terms. In this example, the displaying unit 14Z displays an image corresponding to the selected term in a selectable manner, and displays a details screen of the term when the player selects the image. Note that “selectably displayed” means that the display target is displayed in such a manner that the player can receive the selection of the display target as a system, and the display format may be a “item name list” format at the time of searching for a character string, or may be a format in which the item name and details are displayed together.

FIG. 9 is a flowchart showing an example of a game process corresponding to at least one of the embodiments of the present invention. In the game process in the present example, a process related to controlling the progress of the video game in accordance with the operation of the player is performed. Hereinafter, each process performed by the video game processing system 100Z including the server 10Z will be described. Note that the order of the respective processes is not the same as long as there is no contradiction in the contents of the processes.

The game process is started, for example, when the system 100Z receives an operation input by the player.

In the game process, the system 100Z first specifies a term satisfying the condition to be searched (step S301). In the present example, the system 100Z specifies a term output in accordance with the progress of the video game as a term satisfying the condition to be searched among terms for which the condition to be searched is set.

After specifying the term, the system 100Z determines search information (step S302). In this example, the system 100Z determines the character string input by the player or the category selected by the player as the search information.

Upon determining the search information, the system 100Z selects a term (step S303). In this example, the system 100Z selects a predetermined number of terms that include a character string input by a player in an explanatory sentence or terms that belong to a category selected by a player.

When the term is selected, the system 100Z displays the term (step S304). In this example, system 100Z displays images corresponding to terms in a selectable manner.

Hereinafter, a configuration related to a search for a term in the present example will be described in more detail.

In this example, the system 100Z has a function of displaying a UI aiming at “easy to check” and “happy as content” in a game. This function allows the player to experience collection of terms and confirmation (or investigation) of terms. When the level of knowledge of the virtual world provided as a video game is improved and the game progresses, the “knowledge” increases, and it is possible to provide the player with the fact that the player does not know or wants to know as a game experience. In addition, in the present example, the system 100Z also provides a lead to the “related item” to the player when the player wants to enjoy and naturally read and further know.

In addition, in the present example, the system 100Z has a storage area (Hereinafter, the terminology will be referred to as a terminology.) in which terms satisfying the conditions to be searched are registered. The conditions to be searched include those satisfied when the player progresses the main story, clears the quest, talks with a specific NPC, and debate the enemy. That is, as the player progresses the video game, terms (or items corresponding to the terms) are registered in the terminology.

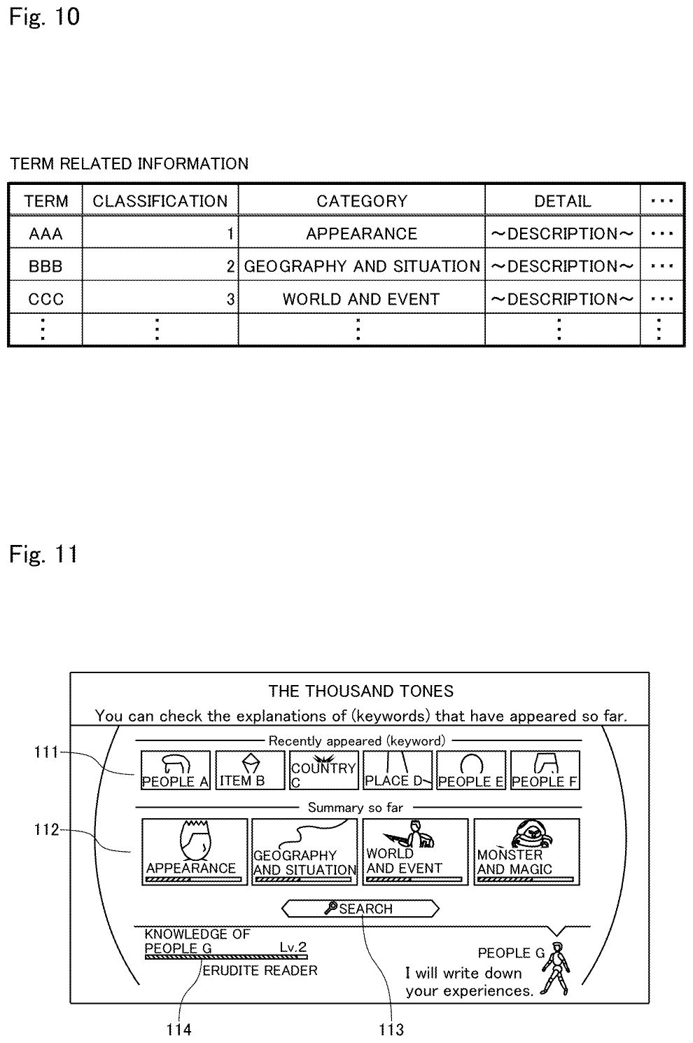

FIG. 10 is an explanatory diagram for explaining an example of information relating to a term (hereinafter referred to as “term related information”). In this example, the term related information associates a term, a classification, a category, and details with each other. The search target condition may be associated with each term, or may be associated with one search target condition (e.g., appearing in a game) for a plurality of terms. Alternatively, information related to the user (e.g., the level of the player) may be associated with each other.

Here, the classification is used to classify the state of the term. The configuration of the classification is not particularly limited, but it is preferable that the player can grasp the state of the term. Examples of states include three classifications: a state (For example, terms that are not displayed during play.) that the player does not know through play of the video game, a state (For example, terms displayed during play.) that the player has heard but is not experienced, and a state (e.g., a term indicating an item used by the player or an area reached) that the player has experienced.

Also, a category means a classification to which at least one term belongs. In addition, detail means information related to a term. Although the details are not particularly limited, in the present example, the details include a description of a term, a details screen of the term, and a link to other information included in the details screen.

In this example, the terminology plays the role of a changing dictionary. When an item is registered, an experience value is added to the player, and when the experience value of the player is accumulated, the level is increased, and special knowledge (item) is given to the player. As a result, the player can easily search for the collected knowledge (items) and confirm the knowledge in the list display, and the knowledge level increases every time the items are collected, so that the player can enjoy playing the video game from the desire to complete even if the player does not have an interest in the world view provided by the video game. The information updated by the item registration is not limited to the experience value, but is preferably information related to the player. Examples of the information relating to the player include information relating to an object that the player can access, such as a parameter update of a character responsible for managing the terminology. In addition, although what is given to the player is not limited to knowledge, it is preferable to be related to item addition. Examples of such privileges include items that can be used in a game, and names that gradually increase in value.

FIG. 11 is an explanatory diagram for explaining an example of a game screen; Here, as a top page, an example of appearance at the start of the game will be described. The game screen shown in FIG. 11 includes a recommendation term area 111 for displaying a recently appearing keyword, a category area 112 for displaying the progress of each category, a search window 113, and an element area 114 for displaying play elements such as experience value gauges.

Here, the recommended term area 111 has a function of recommending an item that the user wishes to see. In this example, data is set on the server side, and the display items are finely changed according to the progress of the game. Although the method of selecting the recommended term is not particularly limited, it is preferable that the player can recognize that the term is linked to the progress of the game. In an example of such a configuration, a term whose date and time at which the condition to be searched is satisfied is close to the present is preferentially selected. With such a configuration, in the recommended term area 111 in the final stage of the game, contents related to the root of the story suitable for the final stage of the game are lined up. As another example, there is a configuration in which appropriate terms are preferentially registered by hand. That is, in the approximate case, there is a configuration in which “the date and time at which the condition to be searched is satisfied is close to the present” is preferentially selected, and when an important term appears again, even if the date and time at which the condition to be searched of the important term is satisfied is older than that of the other terms, the selection is preferentially performed. In addition, a configuration may be adopted in which a term serving as a base is specified, and when the item content is updated to an item according to an arbitrary condition, the latest page displayed here is also updated. That is, for example, in the case where the first page indicating the details of the term “crystal” is registered as the display target in the period of the sequence A, the first page may be displayed for the normal player, but the second page may be displayed for the player who clears the quest and releases the second page. Further, in a case where the player satisfies the predetermined condition (For example, when the story is advanced as the second play after the video game is cleared.), an item corresponding to the “story status of the second round” may be displayed in accordance with the progress of the second round, instead of the registration status of the terminology.

In addition, the category area 112 has a function of presenting the collection status of terms corresponding to each of a predetermined number of categories (i.e., the number of terms satisfying the condition to be searched) to the player. In this example, the progress gauge increases as terms or items corresponding to terms that can be searched by the player gather. Note that the number of categories and the number of displayed categories are not particularly limited, and the categories to be preferentially displayed may be changed according to the game situation. Examples of categories include “appearances” and “monsters and magics” relating to characters, and “geography and situations” and “world and events” relating to virtual spaces. The category corresponding image displayed in the category area 112 may be changed in accordance with the player's operation. When the player selects an image corresponding to a category, a term or an image corresponding to a term belonging to the selected category is displayed. Also in this screen, the display outline changes according to the progress of the game. That is, as for the pages in each category, there are many blanks in the initial stage of the game, the number of images and items increases as the game progresses, and all the images and items are displayed in the complete state.

The search window 113 has a function of receiving an input of a search character string by the player. The configuration for receiving the search character string is not particularly limited, and may be configured to receive an input of an arbitrary character string, or may be configured to selectably display a related word based on a game situation or a display situation of another area.

The element region 114 is responsible for a function of representing a collection state of terms by the player. In this example, an “experience value gauge” is displayed which increases as the items of the term group increase as the terms are collected. Although the configuration of the experience value gauge is not particularly limited, it is preferable that the MAX state indicates a state in which all knowledge is gathered. In this example, when the player progresses the story, the experience value increases and the level of the “knowledge level” increases, special knowledge is added. The time at which the experience value is accumulated is not particularly limited, and may be when the search target condition of the term is satisfied or when the player accesses a specific character or place. For example, in a configuration in which an experience value is accumulated when a specific character is accessed, information (the number of knowledge/items) collected by the player from the previous access to the new access may be converted into an experience value. Further, when the knowledge level rises according to the experience value, a state in which special knowledge (e.g., a keyword) is obtained may be displayed as a moving image. With such a configuration, it is possible to provide the player with an experience of playing the terminology while enjoying the terminology as content rather than the terminology in the game.

Further, in this example, in addition to the search using the search window, a tag search and a 50-tone search are provided. The tag search has a function of responding to a request from a player who is ambiguous in recognition of an item to be searched. That is, for example, when it is desired to know “life”, only items related to “life” are narrowed down by selecting a tag. In addition, in order to allow a large amount of content in the terminology to be interested and viewed with some degree of grouping, a tag (Hereinafter, the tag is referred to as an “associated tag”.) of a subordinate concept related to a tag of a superordinate concept may be provided. The configuration of the related tag is not particularly limited, and a plurality of related tags may be provided in one tag, or a plurality of tags may be associated with one related tag.

The 50-tone search (or name search) is responsible for a function of knowing in more detail the item to which the player knows the name. In this example, the 50-tone search has a function of searching for items in the order of term names by using the unicode and the registered kana data or phonetic character data. In addition, the multi-language may be configured to be capable of performing a language search by all languages by the “number of images”, the “alphabetical order”, or the like.

In addition, in this example, it is preferable that a related link is provided on a screen (Hereinafter, this screen will be referred to as a “details screen”.) for presenting details of terms to the player as a terminology. Here, the related link is a mechanism for presenting an item related to the displayed item to the player. The related link is not particularly limited as long as the related link is configured to present details of a term different from the term being displayed to the player in accordance with the player's operation, but is preferably configured to allow the player to recognize the related term. In addition, for example, a character string representing a related term is displayed so as to be selectable, a UI for transitioning to a link destination when the player selects the character string is provided, and a related link is also provided on the details screen of the transition destination, so that the relationship between a plurality of terms can be easily grasped, and thus the player's desire can be met. In this example, by using the forehead UI, the terminology is provided to the player in the sense of turning the magazine. With such a configuration, even if the screen does not return to the item list screen in order to select an item, after one item is selected, the related link is continuously skipped while the page is switched while the details screen is opened, so that the player can be provided with an experience of viewing the item indefinitely. Note that up to ten small edge UIs of the present example are displayed in an overlapping manner, and up to ten latest link transition histories are stored and can be returned. That is, in the conventional game UI, when one item is selected, a situation of “not proceeding any more” often occurs. For example, in a game UI in which a terminology is provided, when one category is selected from a terminology menu, one term is selected from items in this category, and details of this term can be seen. However, when another item is desired to be viewed, it is necessary to close the displayed item and search for another item from the items in the selected category. Further, when there is no item to be viewed in the items in this category, it is necessary to return to the vocabulary menu and select the category. In other words, in the conventional game UI, the hierarchy of the menu usually becomes deeper as the player performs selection on the UI. On the other hand, in this example, the player can access a plurality of items while opening the “details screen” which should be the lowermost layer. That is, by providing the details screen with the related link, the player can traverse the item or the category in the same hierarchy. In this example, the association between the items is flag-managed separately from the item registration according to the progress of the game of the player.

In addition, the terminology of the present example plays a role of preventing backlash. Conventionally, when a player searches for a person's name or the like using smartphone or the like, there is a possibility that the player may take an unintentional step. On the other hand, in the terminology, the information which the player does not know is not registered in the item by the flag management, and the image of the information which the player does not see is masked. Note that the method of masking an image is not particularly limited as long as it is a mode in which it is possible to prevent backlash to the player. In this example, in the unregistered case, both the term and the image are masked, and in the case where the term is emerging, only the image is masked (the term is displayed), and in the case of the state where the appearance is also known (the final state), the image is not masked. Further, in this example, in addition to spoiler support for the details screen (related words), spoiler support is also provided for tags and related links. That is, for example, when “the item A is related to a specific tag B and is related to another item B” is not clear on a story, a tag or a link is not attached. Similarly, even if the tag E corresponding to the character string E is already associated with the item as data, the tag is controlled so as not to appear as a tag until the name “E” actually appears. On the other hand, there is a case where tagging is not performed by story progression. That is, for example, with respect to a specific character, the tag of the character string Y is attached to the page of the name of the character string X, but the tag of the character string Y may be removed when a new character string Z is updated and added by advancing a story.

Note that, in the terminology of the present example, by adopting a web-like UI, it is possible to “control search results and links according to the game situation of the player” while maintaining high searchability that cannot be lost by the PC or smartphone. In addition, a plurality of mechanisms are prepared to avoid taking away the player's enjoyment of snagging. These are effects in a game in which data of “the progress status of the player” is obtained. In addition to providing a tag search function and a related word function as data management to convey the world appearance of the game, for example, a UI transition to another available activity that can be used in combination with the activity currently confirmed by the player on the activity screen of the action game may be prepared. In addition, in the card game, in consideration of the deck held by the hand, another card which is recommended to be combined with the deck together with the card currently viewed may be registered as the related link. Even in these game genres, as compared with the case of assembling a deck or considering a combo while collecting information by web, a situation in which “access to information to be known” is easily created in the game, so that it is possible to reduce the search opportunity in smartphone or a PC, and to prevent backlash and improve the sense of immersion in content.

In addition, the terminology of the present example is responsible for the read-back function. That is, the terminology can be used not only as a mechanism for providing the player with terms and categories recommended by the system but also as a mechanism for the player to arbitrarily read back with reference to a predetermined database. For example, a predetermined term may be registered in a predetermined database as a condition for displaying a description of the predetermined term to the player. In addition, as a UI different from the terminology, a reading-back function may be provided in which terms displayed in accordance with the progress of the video game and information relating to the terms are registered and can be searched in accordance with a player's operation.

As described above, as one aspect of the third embodiment, since the server 10Z that controls the progress of the video game is configured to include the specifying unit 11Z, the deciding unit 12Z, the selecting unit 13Z, and the displaying unit 14Z, among terms appearing in the video game, terms satisfying the conditions to be searched in accordance with the progress of the video game are identified, search information is determined based on a player operation, and a predetermined number of terms are selected from terms satisfying the conditions to be searched based on the search information, the selected predetermined number of terms can be displayed so that information can be provided without impairing the player's sense of immersion in the video game.

That is, since the search target changes in accordance with the progress of the video game, it becomes easy for the player to check terms in the game, and it becomes easy for the player to enjoy even changed contents, and therefore, it becomes possible to prevent the sense of immersion of the player in the video game from being impaired as compared with the case where the player searches for terms from information outside the video game.

Further, in the example of the third embodiment described above, since the tag associated with the term is used as the search information, it is possible to reduce the burden on the player required for the search as compared with the case where only the search character string is used.

Further, in the example of the third embodiment described above, since the kana characters or phonetic characters are used as the search information, it is possible to reduce the burden on the player required for the search as compared with the case of searching for a term that matches the character string input to the player.

In addition, in the example of the third embodiment described above, since the specified one or more terms are registered in the predetermined storage area, it is possible to provide the player with an experience in which the contents of the term group are enhanced in accordance with the progress of the content.

Further, in the example of the third embodiment described above, an image including a selected term and a link associated with the term is displayed, and when the link is selected by the player, an image corresponding to the link and including at least another link different from the link is displayed, this allows the player to experience so-called net surfing in the game.

Further, in the example of the third embodiment described above, the detailed information in which the term, the category, the details screen, and the link indicating the other details screen are associated with each other is referred to, the category is displayed when the term is selected, the details screen is displayed when the category is selected, the other details screen indicated by the link is displayed when the link to the other information is selected, and the other details screen indicated by the link is changed based on the progress of the video game, the player can access a plurality of items while opening the “details screen” which should be the lowermost layer. That is, it is possible to provide the player with an experience of traversing items or categories in the same layer.

In addition, in the example of the third embodiment described above, since the information related to the player is updated based on a situation in which terms are specified and the benefit is given to the player based on the information related to the player, experience values are accumulated according to the degree of addition of the terminology, and it is possible to attract the player's interest in raising the knowledge level.

Further, in the example of the third embodiment described above, it is possible to determine which state among the predetermined number of states the term is in, display the term in a mode corresponding to the determined state of the term, and provide three-stage classifications of “unknown information”, “unexperienced information which may have been heard”, and “experienced information” in the information as the nested correspondence, and it is possible to prevent the sense of immersion of the player in the video game from being impaired.

Further, in the example of the third embodiment described above, since the term extracted in accordance with the predetermined selection rule among the terms satisfying the condition to be searched is configured to be selectably displayed, even in a case where the number of terms satisfying the condition to be searched is considered to be too large to be displayed on one screen, the term considered to be useful to the player can be preferentially displayed.

As described above, one or more deficiencies are solved by each embodiment of the present application. Note that the effects according to the respective embodiments are one example of a non-limiting effect or effect.

In each of the above-described embodiments, the plurality of player terminals 20 and 201 to 20N and the server 10 execute the above-described various processes in accordance with various control programs (for example, a video game process program) stored in a storage device included therein.

Further, the configuration of the system 100 is not limited to the configuration described as an example of each of the above-described embodiments, and for example, a configuration may be adopted in which a part or the whole of the processing described as the processing executed by the player terminal is executed by the server 10, or a configuration may be adopted in which a part or the whole of the processing described as the processing executed by the server 10 is executed by any of the plurality of player terminals 20 and 201 to 20N (for example, the player terminal 20). For example, in a configuration in which all of the processes described as the processes executed by the server 10 are executed by the player terminal 20, the server 10 becomes unnecessary, and various processes described above are executed by the player terminal 20 alone. In addition, a part or all of the storage unit included in the server 10 may be included in any of the plurality of player terminals 20 and 201 to 20N. That is, a part or all of the functions of one of the player terminal 20 and the server 10 in the system 100 may be included in the other one.

Further, the program may be configured to cause a single device that does not include a communication network to realize part or all of the functions described as examples of the above-described embodiments. In addition, a video game to which a part or all of the functions described as examples of the above-described embodiments are applied is not limited to a video game. That is, the present invention can be applied to metaverse, moving images, and other contents. Further, the network may be a network using distributed processing ledger technology, or may be content using NFT.

According to one embodiment of the present invention, it is useful to provide information without impairing the sense of immersion in a video game of a player.

### APPENDIXES

The above description of the embodiments describes at least the following invention so that those skilled in the art can practice the invention.

(1)

A non-transitory computer-readable medium storing a video game processing program that, when executed, causes a server to perform:
specifying one or more terms that satisfy a search target condition in accordance with a progress of a video game from among a plurality of terms that appear in the video game;
deciding search information based on an operation of a player;
selecting a predetermined number of terms from among the specified one or more terms based on the search information; and
displaying the selected predetermined number of terms.
   (2)

The non-transitory computer-readable medium according to (1), wherein the program, when executed, causes the server to further perform:
determining which state among a predetermined number of states each of the selected terms is in; and
displaying each of the selected terms in a manner corresponding to the determined state.
   (3)

The non-transitory computer-readable medium according to (1) or (2), wherein the program, when executed, causes the server to perform:
selecting the predetermined number of terms by using kana as the search information.
   (4)

The non-transitory computer-readable medium according to any one of (1) to (3), wherein the program, when executed, causes the server to further perform:
registering the specified one or more terms in a predetermined storage area.
   (4-1)

The non-transitory computer-readable medium according to any one of (1) to (4), wherein the program, when executed, causes the server to further perform:
selecting a term corresponding to the progress of the video game from the specified one or more terms; and
displaying the selected term as a term corresponding to the progress of the video game in a recommended term area.
   (5)

The non-transitory computer-readable medium according to any one of (1) to (4), wherein the program, when executed, causes the server to further perform:
displaying a first image including each of the selected terms and a first link associated with each of the selected terms; and
if the first link is selected by the player, displaying a second image corresponding to the first link and including at least a second link different from the first link.
   (5-1)

The non-transitory computer-readable medium according to any one of (1) to (4), wherein the program, when executed, causes the server to further perform:
referring to detailed information including a term, a category, a first details screen, and a link associated with each other, the link indicating a second details screen;
displaying the category if the term is selected;
displaying the first details screen if the category is selected;
displaying the second details screen indicated by the link if the link is selected; and
changing the second details screen indicated by the link based on the progress of the video game.
   (6)

The non-transitory computer-readable medium according to any one of (1) to (5), wherein the program, when executed, causes the server to further perform:
updating information related to the player based on the specified one or more terms; and
awarding a benefit to the player based on the information related to the player.
   (7)

The non-transitory computer-readable medium according to any one of (1) to (6), wherein the program, when executed, causes the server to further perform:
determining which state among a predetermined number of states each of the selected terms is in; and
displaying each of the selected terms in a manner corresponding to the determined state.
   (8)

The non-transitory computer-readable medium according to any one of (1) to (7), wherein the program, when executed, causes the server to further perform:
extracting a term among the specified one or more terms that satisfy the search target condition, according to a predetermined selection rule; and
selectably displaying the extracted term.
   (9)

A non-transitory computer-readable medium storing a video game processing program, when executed, causes a user terminal to perform at least one function of the functions that the video game processing program described in any one of (1) to (8) causes the server to perform, the user terminal capable of communicating with the server.

(10)

A video game processing system, comprising:
a communication network;
a server;
a player terminal; and
one or more processors configured to:
   specify one or more terms that satisfy a search target condition in accordance with a progress of a video game from among a plurality of terms that appear in the video game;
   decide search information based on an operation of a player;
   select a predetermined number of terms from among the specified one or more terms based on the search information; and
   display the selected predetermined number of terms.
      (11)

The video game processing system according to (10),
wherein the server includes the one or more processors, and
wherein the player terminal includes an processor configured to display the selected predetermined number of terms.
   (12)

A non-transitory computer-readable medium storing a video game processing program that, when executed, causes a player terminal to perform:
specifying one or more terms that satisfy a search target condition in accordance with a progress of a video game from among a plurality of terms that appear in the video game;
deciding search information based on an operation of a player;
selecting a predetermined number of terms from among the specified one or more terms based on the search information; and
displaying the selected predetermined number of terms.
   (13)

A video game processing method, comprising:
specifying one or more terms that satisfy a search target condition in accordance with a progress of a video game from among a plurality of terms that appear in the video game;
search information based on an operation of a player;
selecting a predetermined number of terms from among the specified one or more terms based on the search information; and
displaying the selected predetermined number of terms.
   (14)

A video game processing method in which a video game processing system including a communication network, a server, and a player terminal controls progress of a video game, the video game processing method comprising:
specifying one or more terms that satisfy a search target condition in accordance with a progress of a video game from among a plurality of terms that appear in the video game;
search information based on an operation of a player;
selecting a predetermined number of terms from among the specified one or more terms based on the search information; and
displaying the selected predetermined number of terms.

What is claimed is:

1. A non-transitory computer-readable medium storing a video game processing program that, when executed, causes a server to perform:
specifying one or more terms that satisfy a search target condition in accordance with a progress of a video game from among a plurality of terms that appear in the video game;
deciding search information based on an operation of a player;
selecting a predetermined number of terms from among the specified one or more terms based on the search information; and
displaying the selected predetermined number of terms.

2. The non-transitory computer-readable medium according to claim 1, wherein the program, when executed, causes the server to further perform:
determining which state among a predetermined number of states each of the selected terms is in; and
displaying each of the selected terms in a manner corresponding to the determined state.

3. The non-transitory computer-readable medium according to claim 1, wherein the program, when executed, causes the server to perform:
selecting the predetermined number of terms by using kana as the search information.

4. The non-transitory computer-readable medium according to claim 1, wherein the program, when executed, causes the server to further perform:
registering the specified one or more terms in a predetermined storage area.

5. The non-transitory computer-readable medium according to claim 1, wherein the program, when executed, causes the server to further perform:
selecting a term corresponding to the progress of the video game from the specified one or more terms; and
displaying the selected term as a term corresponding to the progress of the video game in a recommended term area.

6. The non-transitory computer-readable medium according to claim 1, wherein the program, when executed, causes the server to further perform:
displaying a first image including each of the selected terms and a first link associated with each of the selected terms; and
if the first link is selected by the player, displaying a second image corresponding to the first link and including at least a second link different from the first link.

7. The non-transitory computer-readable medium according to claim 1, wherein the program, when executed, causes the server to further perform:
referring to detailed information including a term, a category, a first details screen, and a link associated with each other, the link indicating a second details screen;
displaying the category if the term is selected;
displaying the first details screen if the category is selected;
displaying the second details screen indicated by the link if the link is selected; and
changing the second details screen indicated by the link based on the progress of the video game.

8. The non-transitory computer-readable medium according to claim 1, wherein the program, when executed, causes the server to further perform:
updating information related to the player based on the specified one or more terms.

9. The non-transitory computer-readable medium according to claim 1, wherein the program, when executed, causes the server to further perform:
extracting a term among the specified terms according to a predetermined selection rule; and
selectably displaying the extracted term.

10. A video game processing system, comprising:
a communication network;
a server;
a player terminal; and
one or more processors configured to:
specify one or more terms that satisfy a search target condition in accordance with a progress of a video game from among a plurality of terms that appear in the video game;
decide search information based on an operation of a player;
select a predetermined number of terms from among the specified one or more terms based on the search information; and
display the selected predetermined number of terms.

11. A non-transitory computer-readable medium storing a video game processing program that, when executed, causes a player terminal to perform:
specifying one or more terms that satisfy a search target condition in accordance with a progress of a video game from among a plurality of terms that appear in the video game;
deciding search information based on an operation of a player;
selecting a predetermined number of terms from among the specified one or more terms based on the search information; and
displaying the selected predetermined number of terms.
